(19) United States
(12) Patent Application Publication
(10) Pub. No.: US 2025/0252400 A1
(43) Pub. Date: Aug. 7, 2025

(54) ONLINE COLLABORATION USING GROUP MEETING PLATFORM

(71) Applicant: Class Technologies Inc., Washington, DC (US)

(72) Inventor: Michael L. Chasen, Bethesda, MD (US)

(21) Appl. No.: 18/625,596

(22) Filed: Apr. 3, 2024

Related U.S. Application Data
(60) Provisional application No. 63/549,106, filed on Feb. 2, 2024.

(51) Int. Cl. G06Q 10/10; G06F 3/04855; G06T 11/60; G11B 27/031; H04N 7/15

(52) U.S. Cl. CPC G06Q 10/103; G06F 3/04855; G06T 11/60; G11B 27/031; H04N 7/15

(57) ABSTRACT

A method for online collaboration displays a user interface for real-time communication between a group of users and displays thumbnails within a user interface to the users, each thumbnail corresponding to a user. The method receives through the user interface a selection input from a particular user, the selection input including a selection of a file. In response to the selection input, the method displays an editing interface to the users, the editing interface adapted for real-time editing of files. The method displays the file within the editing interface to the users, and receives simultaneously through the editing interface, a first editing input from a first user and a second editing input from a second user. The method modifies the file in response to the first editing input and the second editing input and displays the modified file within the editing interface to the users.

### CROSS-REFERENCE OF RELATED APPLICATION

This application claims the benefit of U.S. Provisional Application No. 63/549,106, filed on Feb. 2, 2024, which is incorporated herein in its entirety.

### TECHNICAL FIELD

The present disclosure generally relates to platforms for synchronous group meetings, and more particularly to systems for collaborative sharing of files.

### BACKGROUND

Group meeting platforms provide users with an online environment that enables interaction and collaboration without requiring a physical presence. Such platforms provide group video, audio, and chat, and enable a user to share their screen or a document with other users in the meeting session. However, such sharing does not allow for multiple users to collaborate on a document, forcing the users to rely on software external to the group meeting platform to collaborate and edit files.

In addition, while such group meeting platforms may support allowing more than one user to share a file at the same time, the user interface of such platforms makes it difficult and cumbersome to access multiple shares and switch between them, often requiring multiple clicks and hunting through menu options.

As such, there is a need for improving group meeting platforms to make it easier for users to swap between multiple shared files, and to collaboratively edit files.

### SUMMARY

Some embodiments of the present disclosure provide a method for online collaboration. The method includes displaying, to users, a user interface for a real-time communication session between the users. The method further includes displaying thumbnails within a first region of the user interface to the users, each thumbnail corresponding to a user. The method further includes receiving through the user interface a selection input from a particular user, the selection input including a selection of a particular file. In response to the selection input, the method further displays an editing interface within a second region of the user interface to the users, the editing interface adapted for real-time editing of files. The method further includes displaying the particular file within the editing interface to the users, and receiving simultaneously through the editing interface, a first editing input from a first user and a second editing input from a second user. The method further includes modifying the particular file in response to the first editing input and the second editing input, resulting in a modified file, and displaying the modified file within the editing interface to the users.

Some embodiments of the present disclosure provide a non-transitory computer-readable medium storing a program for online collaboration. The program, when executed by a computer, configures the computer to display, to users, a user interface for a real-time communication session between the users. The executed program further configures the computer to display thumbnails within a first region of the user interface to the users, each thumbnail corresponding to a user. The executed program further configures the computer to receive through the user interface a selection input from a particular user, the selection input including a selection of a particular file. In response to the selection input, the executed program further configures the computer to display an editing interface within a second region of the user interface to the users, the editing interface adapted for real-time editing of files. The executed program further configures the computer to display the particular file within the editing interface to the users, and receive simultaneously through the editing interface, a first editing input from a first user and a second editing input from a second user. The executed program further configures the computer to modify the particular file in response to the first editing input and the second editing input, resulting in a modified file, and display the modified file within the editing interface to the users.

Some embodiments of the present disclosure provide a system for online collaboration. The system comprises a processor and a non-transitory computer readable medium storing a set of instructions, which when executed by the processor, configure the processor to display, to users, a user interface for a real-time communication session between the users. The executed instructions further configure the processor to display thumbnails within a first region of the user interface to the users, each thumbnail corresponding to a user. The executed instructions further configure the processor to receive through the user interface a selection input from a particular user, the selection input including a selection of a particular file. In response to the selection input, the executed instructions further configure the processor to display an editing interface within a second region of the user interface to the users, the editing interface adapted for real-time editing of files. The executed instructions further configure the processor to display the particular file within the editing interface to the users, and receive simultaneously through the editing interface, a first editing input from a first user and a second editing input from a second user. The executed instructions further configure the processor to modify the particular file in response to the first editing input and the second editing input, resulting in a modified file, and display the modified file within the editing interface to the users.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement an online collaboration platform, according to some embodiments.

FIG. 2 is a block diagram illustrating details of a system for online collaboration, according to some embodiments.

FIG. 3 is a flowchart illustrating a process for online collaboration, according to some embodiments.

FIG. 4A shows a user interface for online collaboration, according to some embodiments.

FIG. 4B shows the user interface of FIG. 4A, with sort options enabled.

FIG. 4C shows the user interface of FIG. 4A, displaying a file type selection menu.

FIG. 4D shows the user interface of FIG. 4A, displaying a file browser menu to select a data file for collaboration.

FIG. 4E shows the user interface of FIG. 4A, displaying a URL entry field to select a network resource for collaboration.

FIG. 4F shows the user interface of FIG. 4A, displaying a permissions and options interface to apply to a file shared for collaboration.

FIG. 4G shows an example of collaborative sharing of a word processing document within an editing interface of the user interface of FIG. 4A, according to some embodiments.

FIG. 4H shows an example of collaborative sharing of a presentation document within an editing interface of the user interface of FIG. 4A, according to some embodiments.

FIG. 4I shows an example of collaborative sharing of a spreadsheet document within an editing interface of the user interface of FIG. 4A, according to some embodiments.

FIG. 4J shows an example of collaborative sharing of a web page within an editing interface of the user interface of FIG. 4A, according to some embodiments.

FIG. 4K shows an example of collaborative code review within an editing interface of the user interface of FIG. 4A, according to some embodiments.

FIG. 5 is a flowchart illustrating a process for online collaboration and query of a file, according to some embodiments.

FIG. 6 shows a user interface for online collaboration and queries, according to some embodiments.

FIG. 7 shows a flowchart illustrating a process for online collaboration, according to some embodiments.

FIGS. 8A, 8B, and 8C show another example of a user interface for online collaboration, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure provide a solution to the above-described problems. Specifically, some embodiments provide a system to enable both real-time communication and real-time collaboration.

Some aspects of the present disclosure make it easy to switch between people that are sharing their screen, and easily return to the full meeting. Specifically, some embodiments provide a tabbed interface to access multiple users sharing their screen during an online meeting. The tabbed interface provides direct visual indication of which users and/or how many users are sharing their screen and provides for one-click switching between shared presentations and files, as well as one-click return to the meeting as a whole.

Some embodiments of the present disclosure enable users to collaboratively edit and/or navigate a file or document in real-time, from within the group meeting platform interface, instead of having to use an external file collaboration tool. This integration of real-time editing with file-sharing improves efficiency and facilitates collaboration, by allowing users to exploit the improved communication and discussion features of the group meeting platform, while working together to edit a file or other document.

The term “collaboration” as used herein refers, according to some embodiments, to the cooperative effort of multiple users working on a shared digital document or file in real-time. This collaborative process allows users to concurrently edit, view, navigate, and/or contribute to the content, fostering efficient communication and teamwork. The system typically involves a cloud-based platform or server that hosts the file, enabling seamless synchronization of changes made by different collaborators.

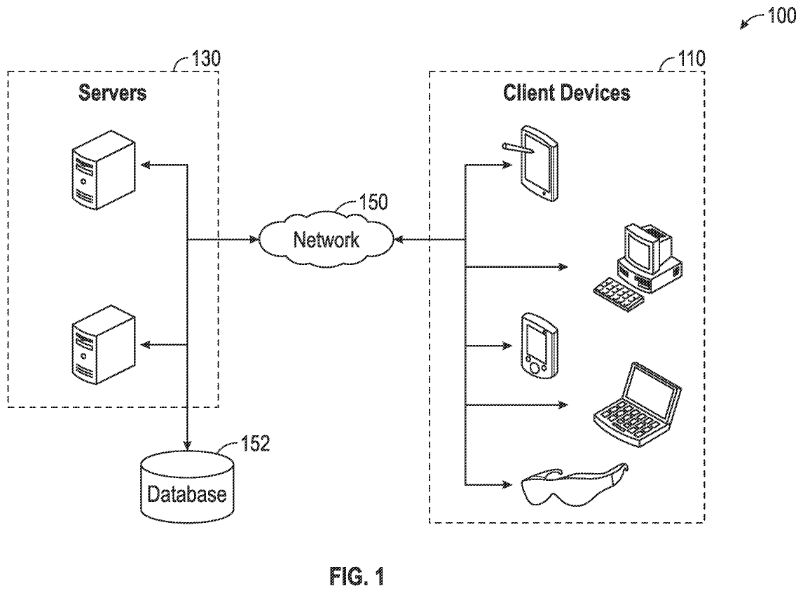

FIG. 1 illustrates a network architecture 100 used to implement an online collaboration platform, according to some embodiments. The network architecture 100 may include servers 130 and a database 152, communicatively coupled with multiple client devices 110 via a network 150. Client devices 110 may include, but are not limited to, laptop computers, desktop computers, and the like, and/or mobile devices such as smart phones, palm devices, video players, headsets, tablet devices, and the like.

The network 150 may include, for example, any one or more of a local area network (LAN), a wide area network (WAN), the Internet, and the like. Further, the network 150 may include, but is not limited to, any one or more of the following network topologies, including a bus network, a star network, a ring network, a mesh network, a star-bus network, tree or hierarchical network, and the like.

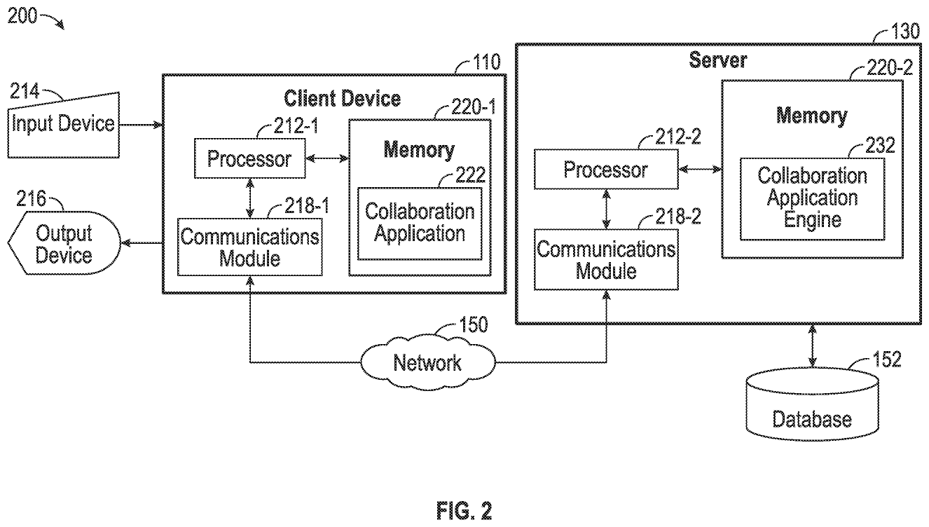

FIG. 2 is a block diagram illustrating details of a system 200 for online collaboration having at least one of client device 110, at least one of servers 130, and a network architecture 100 as disclosed herein, according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency (RF), near field communications (NFC), Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units and other sensors configured to provide input data to a VR/AR headset. Output device 216 may be a screen display, a touchscreen, a speaker, and the like.

Client device 110 may also include a processor 212-1, configured to execute instructions stored in a memory 220-1, and to cause the client device 110 to perform at least some operations in methods consistent with the present disclosure. Memory 220-1 may further include a collaboration application 222, configured to run in client device 110 and couple with input device 214 and output device 216. The collaboration application 222 may be downloaded by the user from server 130, and/or may be hosted by server 130. The collaboration application 222 includes specific instructions which, when executed by processor 212-1, cause operations to be performed according to methods described herein. In some embodiments, the collaboration application 222 runs on an operating system (OS) installed in client device 110. In some embodiments, collaboration application 222 may run within a web browser. In some embodiments, the processor 212-1 is configured to control a graphical user interface (GUI) for the user of one of client devices 110 accessing the server 130.

Database 152 may store data and files associated with the server 130 from the collaboration application 222. In some embodiments, client device 110 collects data, including but not limited to video and images, for upload to server 130 using collaboration application 222, to store in the database 152.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a collaboration application engine 232. The collaboration application engine 232 may be configured to perform operations and methods according to aspects of embodiments. The collaboration application engine 232 may share or provide features and resources with the client device, including multiple tools associated with data, image, video collection, capture, or applications that use data, images, or video retrieved with collaboration application engine 232 (e.g., collaboration application 222). The user may access the collaboration application engine 232 through the collaboration application 222, installed in a memory 220-1 of client device 110. Accordingly, collaboration application 222 may be installed by server 130 and perform scripts and other routines provided by server 130 through any one of multiple tools. Execution of collaboration application 222 may be controlled by processor 212-1.

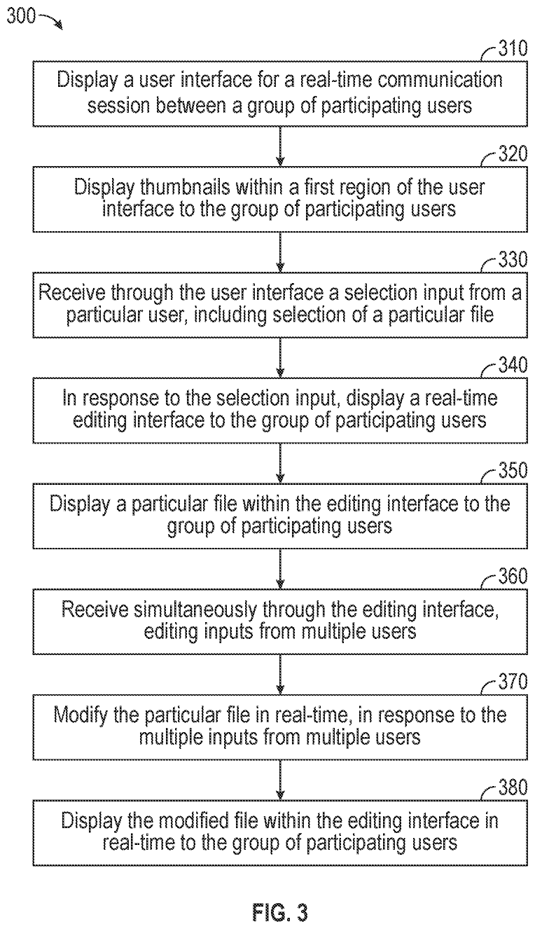

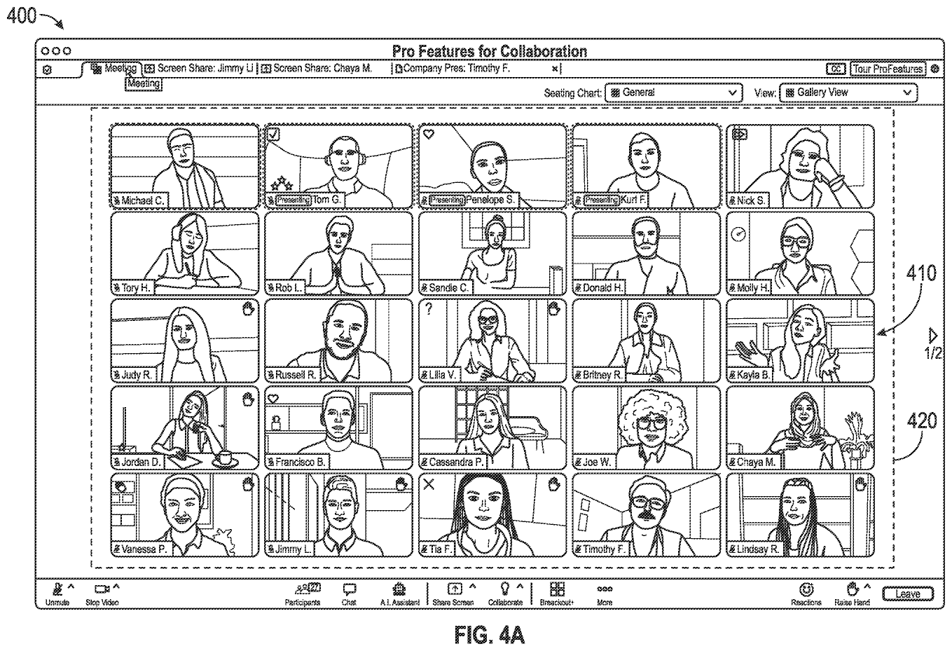

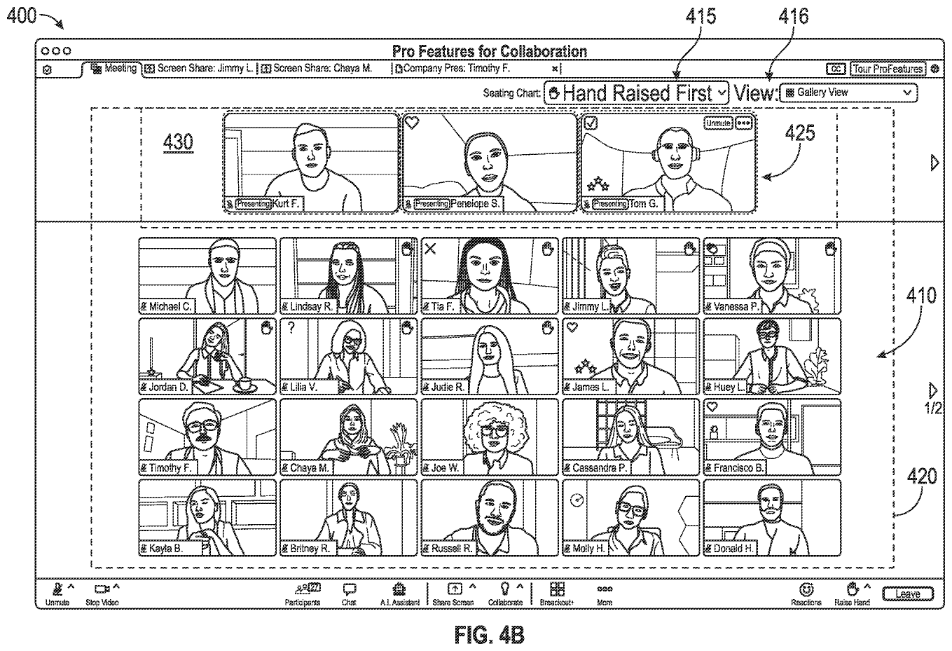

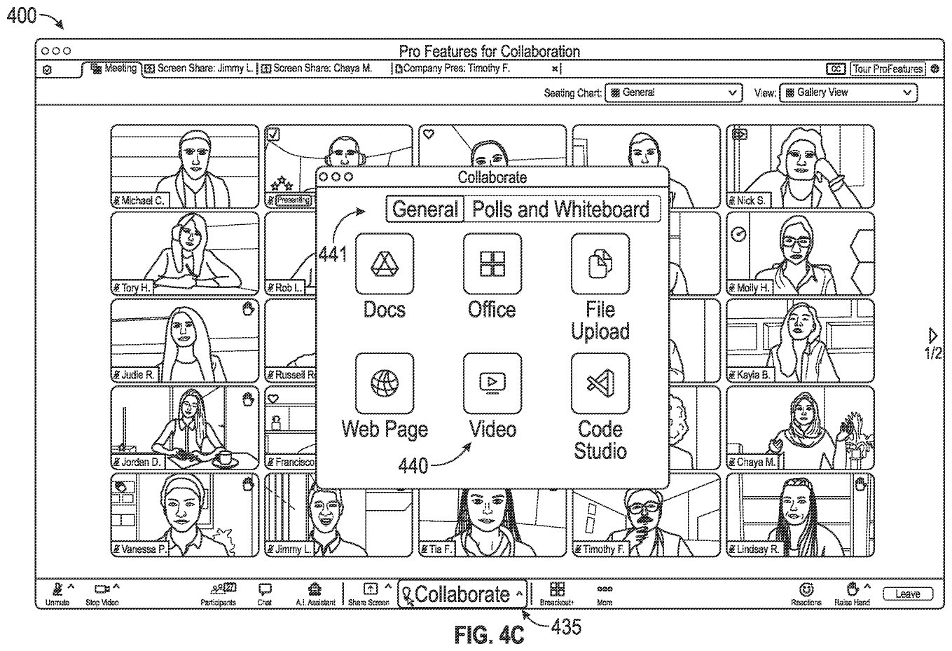

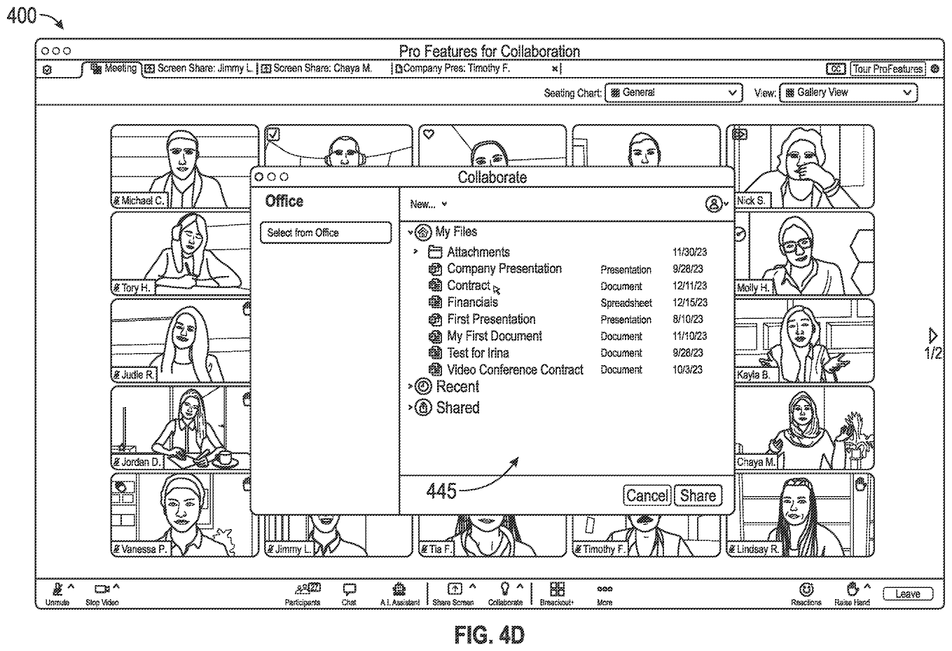

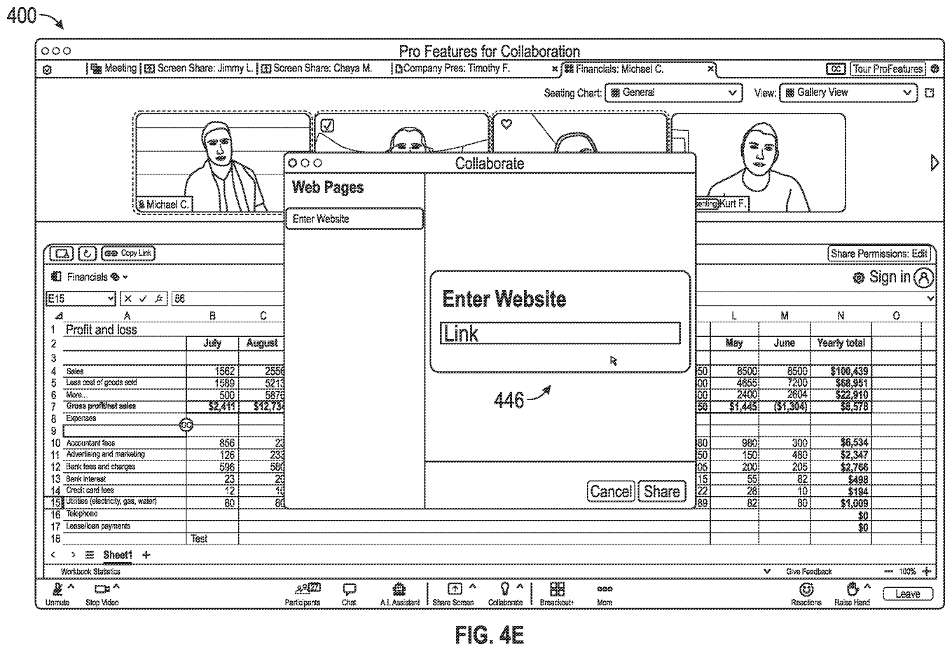

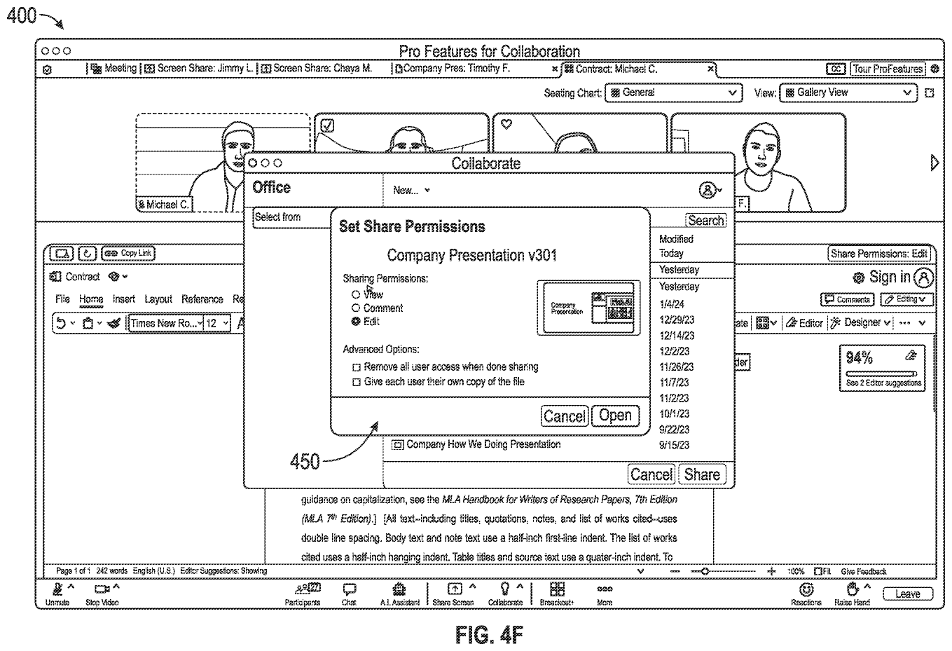

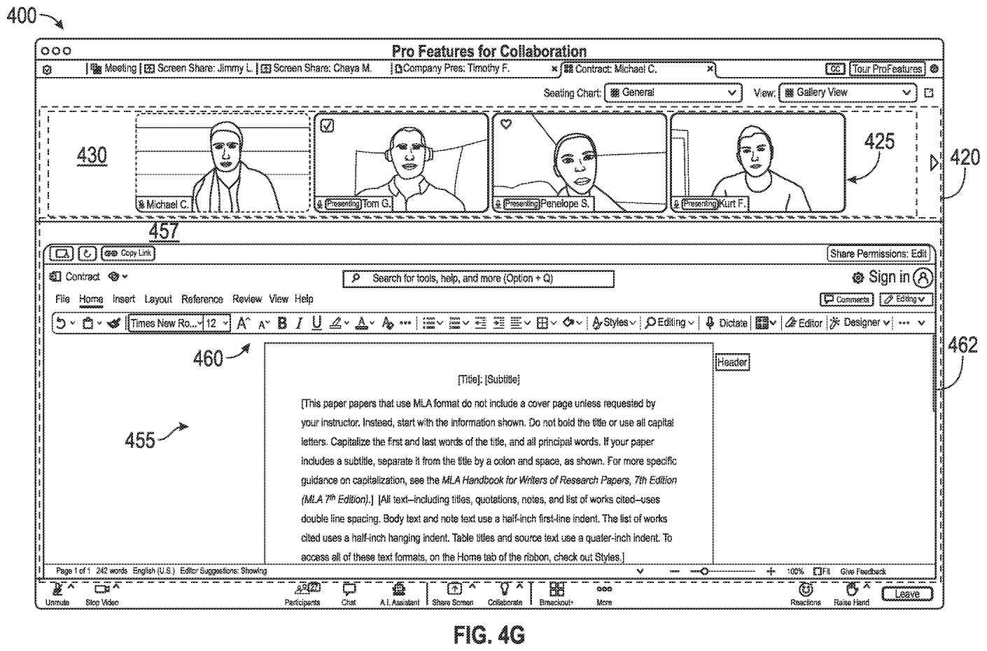

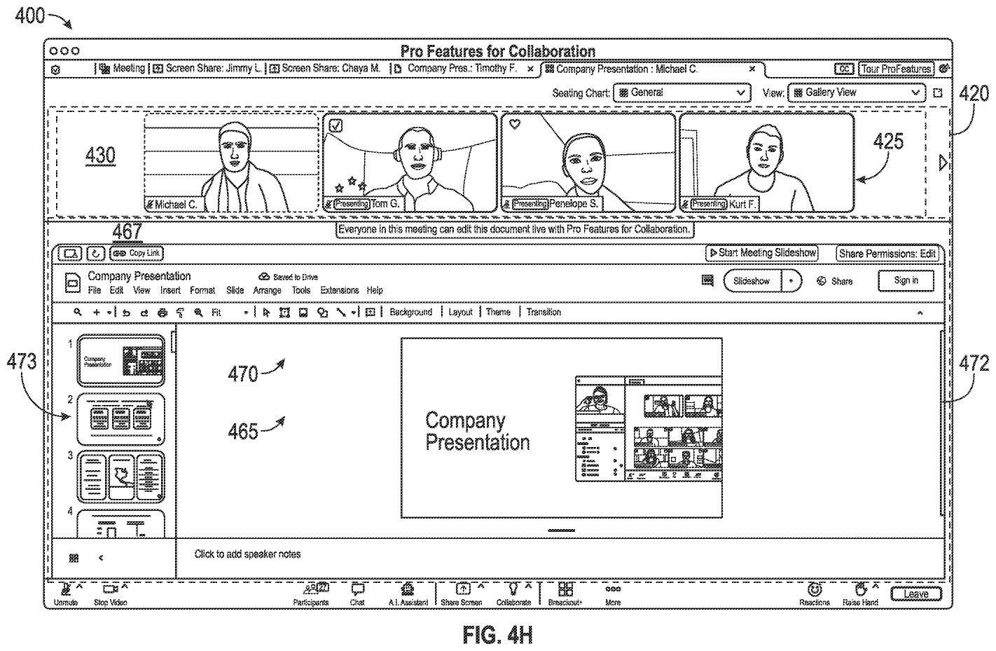

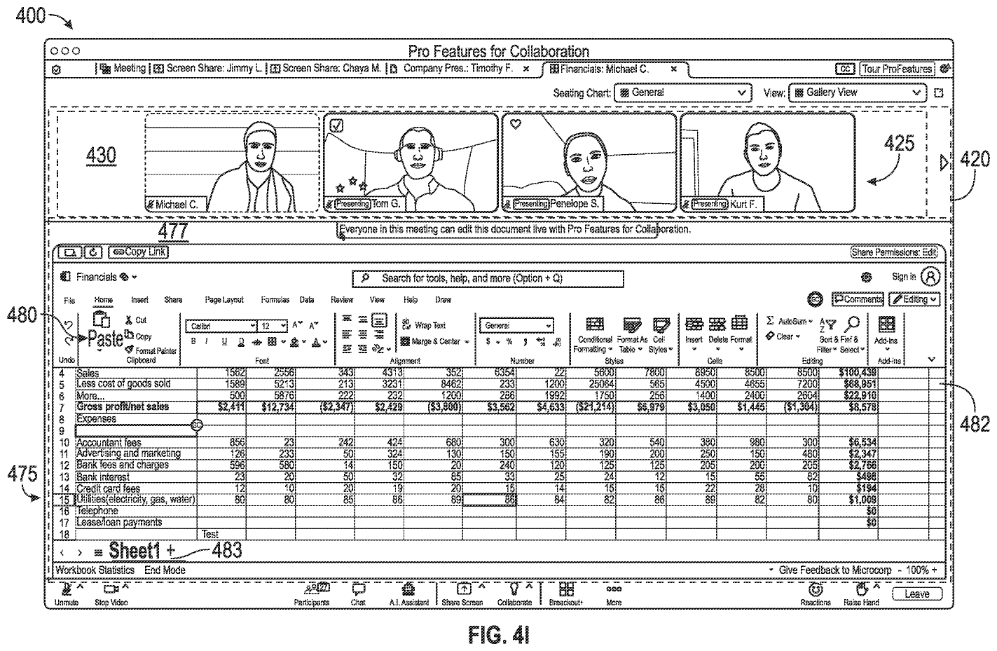

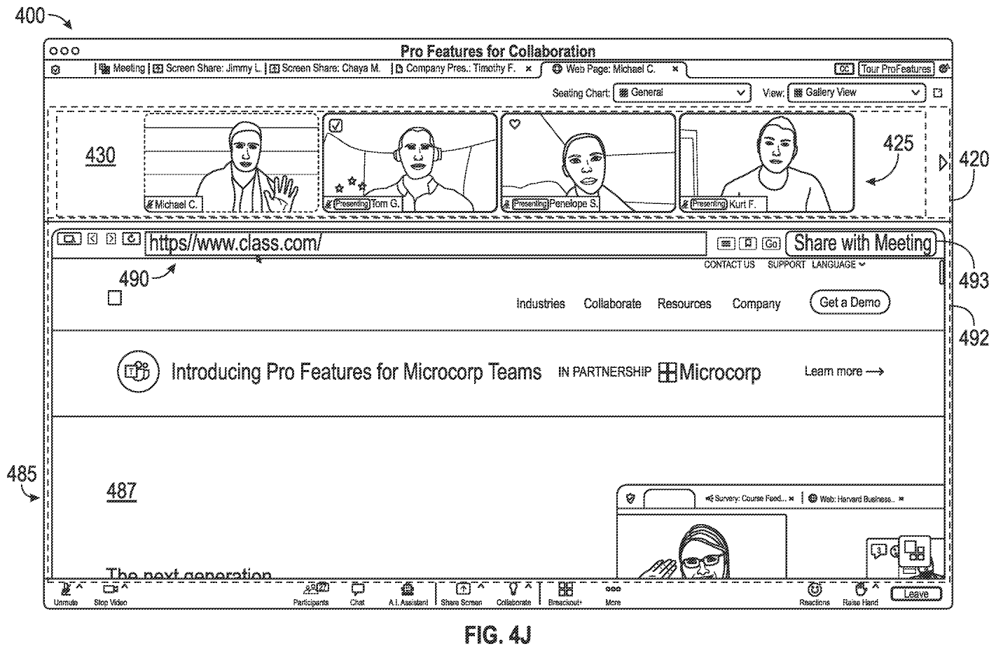

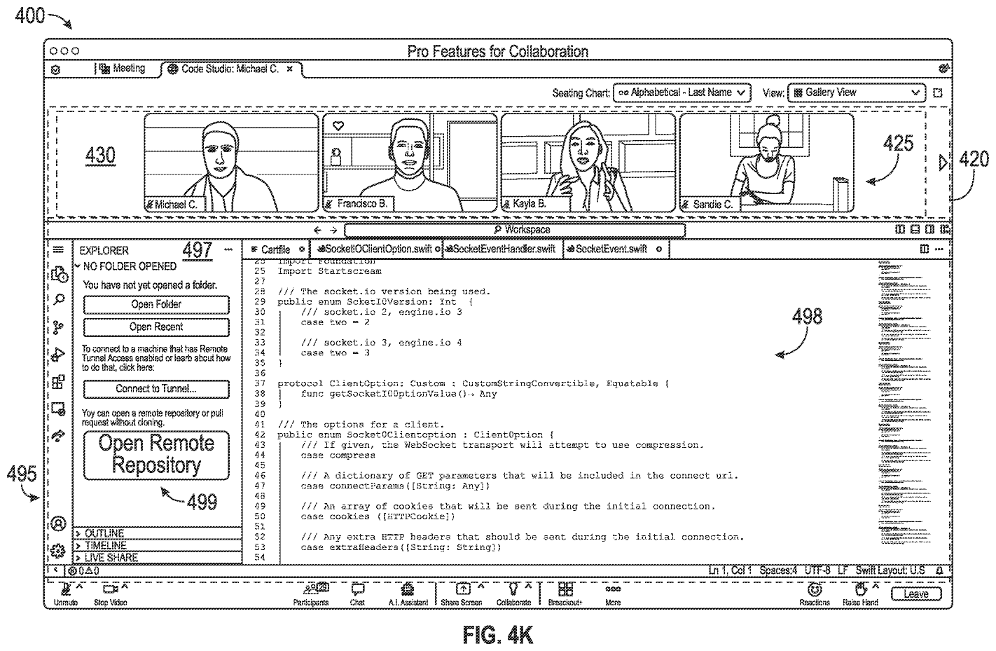

FIG. 3 is a flowchart illustrating a process 300 for online collaboration performed by a client device (e.g., client device 110, etc.) and/or a client server (e.g., server 130, etc.), according to some embodiments. In some embodiments, one or more operations in process 300 may be performed by a processor circuit (e.g., processors 212, etc.) executing instructions stored in a memory circuit (e.g., memories 220, etc.) of a system (e.g., system 200, etc.) as disclosed herein. For example, operations in process 300 may be performed by collaboration application 222, collaboration application engine 232, or some combination thereof. Moreover, in some embodiments, a process consistent with this disclosure may include at least operations in process 300 performed in a different order, simultaneously, quasi-simultaneously, or overlapping in time. The process 300 will be discussed with reference to an exemplary example shown in FIGS. 4A to 4J, which are described in further detail below.

At 310, the process 300 displays a user interface (e.g., user interface 400 described below with reference to FIG. 4A) for a real-time communication session between a group of participating users. The real-time communication session between the participating users may support multiple types of communication including but not limited to video, audio, text, and any combination thereof.

At 320, the process 300 displays thumbnails within a first region of the user interface to the participating users. As an example, FIG. 4A shows a user interface 400, which in its default state shows a grid of user thumbnails 410 (equivalently referred to as a “gallery” or a “video wall”) in a main panel 420. Each individual thumbnail corresponds to a unique user that is participating in the communication session. In some embodiments, the thumbnails 410 may be any representation of the user that the user desires, including but not limited to a user avatar, a user image, a user video, a live user video feed, and a user text identifier. Users may, for example, choose to have a live video feed when their camera is on, and when their camera is off, use a non-video option like an avatar, an image, or text.

In some embodiments, the thumbnails 410 are sortable (or reverse-sortable) according to various user criteria, including but not limited to meeting joining time (e.g., the time each user joined the communication session), alphabetically by first or last name, and user reactions (e.g., various emoji such as thumbs up or smiley face, or a raised hand emoji to indicate a question, etc.). Additional sort criteria may include requiring all participants to use the host's sorting of thumbnails (e.g., enabling a “follow host video order” setting), and a “front of room” feature in which thumbnails for either presenters or speakers are highlighted for all participants. In some embodiments, more than one sort option may be used at the same time.

As an example, FIG. 4B shows the user interface 400 with sort controls 415 adjacent to the main panel 420 (here labeled “seating chart”). The sort controls 415 can be used to select from different sort criteria, which causes a re-ordering of the thumbnails 410 within the main panel 420. In this example, the thumbnails 410 are sorted according to which user raised a hand emoji first (indicating that they have a question), allowing the host to answer and address their questions in turn.

Additional sort controls 416 may also be available (e.g., in FIG. 4B, labeled “view”). The sort controls 416 may be used to select different view options, including but not limited to a default gallery view (i.e., the grid of thumbnails 410), a full screen view, hiding the user's own view (referred to as “self-view”), hiding non-video users, a current speaker view, and a “front of room” feature that highlights users who are currently presenting and/or sharing a file.

In the example of FIG. 4B, the sort criteria have been set to “hand raised first” which puts all users with a raised hand emoji first in the grid of thumbnails 410. In addition, the view option for “front of room” has also been enabled, so that a set of the thumbnails 410 for the presenters 425 are shown in larger size and in a banner 430 at the top of the main panel 420, displacing some of the thumbnails 410.

At 330, the process 300 receives through the user interface a selection input from a particular user. The selection input includes a selection of a file for collaboration and may also include a selection of a collaboration command. Various types of files may be selected by the particular user for collaboration, including but not limited to a document, a spreadsheet, a presentation, a web page, a video, a program, a form, a poll, and a whiteboard.

In some embodiments, the file types include cloud-based document software such as word processing, spreadsheet, and presentation software. In some embodiments, the file types may include any local file that the user desires to share for collaboration.

As an example, FIG. 4C shows the user interface 400 after a “collaborate” control 435 has been clicked by the particular user, which causes a file type selection menu 440 to be displayed to the particular user. Supported file types are represented in this example by clickable icons on the file type selection menu 440 corresponding to each file type. Alternatively, different file types may be selected by the particular user using a menu, a list, or other type of selection control. The file types may be organized into groups, as in this example, using tabs 441.

In some embodiments, receiving the selection input includes selecting, by the particular user, a storage location associated with the particular user from which to retrieve the file. As an example, FIG. 4D shows a file browser 445 allowing the particular user to select a file from a folder labeled “My Files” that the user has access to. The storage location associated with the particular user may be, but is not limited to, one of a local storage, a network-attached storage, and a cloud storage. The file browser 445 would be shown to the particular user after selecting a data file type such as a document, a spreadsheet, a presentation, etc. by clicking, for example, on the corresponding icon on the file type selection menu 440.

In some embodiments, where the file is a web page or other network resource, receiving the selection input includes specifying, by the particular user, a network location (e.g., a Uniform Resource Locator such as a hyperlink address) from which to retrieve the resource. As an example, FIG. 4E shows a URL entry field 446 allowing the particular user to specify a specific webpage. The URL entry field 446 would be shown to the particular user after selecting a network resource file type such as a webpage, an online video, etc. by clicking, for example, on the corresponding icon on the file type selection menu 440.

In some embodiments, receiving the selection input includes receiving, from the particular user, a selection of a permissions parameter that is applicable to users other than the particular user initiating the collaboration. As an example, FIG. 4F shows a permissions interface 450, that allows the particular user to select different levels of permissions, including but not limited to view permission (other users may only view the file), comment permission (other users may leave comments on the file but may not edit the file itself) and edit permission (other users may edit the file themselves).

In some embodiments, receiving the selection input includes receiving, from the particular user, a selection of an options parameter that governs the permissions that users (other than the particular user, who owns the file) may or may not retain after the collaboration is terminated. As an example, the permissions interface 450 shown in FIG. 4F also shows an option to remove all permissions from the other users once the particular user is done sharing the file for collaboration, and also shows an option to afterwards provide a copy of the file (including any modifications made during the collaboration) to the other users.

At 340, the process 300, in response to the selection input, displays in the user interface 400 an editing interface (e.g., editing interfaces 455, 465, 475, 485, and 495 described with reference to FIGS. 4G, 4H, 4I, 4J, and 4K below, respectively) that is shown to all the users participating in the session, and that enables real-time simultaneous editing of the file by all the users. The editing interface may include multiple user controls that permit each user to independently edit the file, including but not limited to text entry fields, menus, icons, and toolbars.

In some embodiments, the editing interface includes navigation controls that are shown to all the users participating in the session, and that enables real-time simultaneous navigation within the file by all the users. The navigation controls permit each user to independently navigate the file, including but not limited to scroll bars, tabs, thumbnail previews, and filters.

At 350, the process 300 displays the file within the editing interface to all the users participating in the session. In some embodiments, displaying the file includes copying the file from the storage location associated with the user to a cache or a remote storage (e.g., database 152) that is part of the collaboration system (e.g., system 200), and not associated with any user. Alternatively, in some embodiments, displaying the file includes retrieving a network resource from an external location (e.g., a URL).

FIG. 4G shows an example of collaborative sharing of a word processing document within an editing interface 455, according to some embodiments. The editing interface 455 is shown within a sub-panel 457 of the main panel 420, that hides some or all of the thumbnails 410. In this example, the “front of room” option is enabled, that shows presenters 425 in a banner 430, within the main panel 420 but outside the sub-panel 457. Alternatively, the editing interface 455 may also be expanded to occupy the entire main panel 420. Each user may determine their own view options independently, to decide how much of the user interface 400 is occupied by the editing interface 455 and/or the sub-panel 457.

The editing interface 455 includes input and formatting controls 460, including but not limited to toolbars, menus, and text entry. The editing interface includes navigation controls, such as a vertical scroll bar 462 that allows other users to independently scroll different pages of the word processing document within the editing interface 455.

FIG. 4H shows an example of collaborative sharing of a presentation document within an editing interface 465, according to some embodiments. The editing interface 465 is shown within a sub-panel 467 of the main panel 420, that hides some or all of the thumbnails 410. In this example, the “front of room” option is enabled, that shows presenters 425 in a banner 430, within the main panel 420 but outside the sub-panel 467. Alternatively, the editing interface 465 may also be expanded to occupy the entire main panel 420. Each user may determine their own view options independently, to decide how much of the user interface 400 is occupied by the editing interface 465 and/or the sub-panel 467.

The editing interface 465 includes input and formatting controls 470, including but not limited to toolbars, menus, and a canvas. The editing interface includes navigation controls, such as a vertical scroll bar 472 and a thumbnail preview 473 that allows other users to independently scroll different slides of the presentation document within the editing interface 465.

FIG. 4I shows an example of collaborative sharing of a spreadsheet document within an editing interface 475, according to some embodiments. The editing interface 475 is shown within a sub-panel 477 of the main panel 420, that hides some or all of the thumbnails 410. In this example, the “front of room” option is enabled, that shows presenters 425 in a banner 430, within the main panel 420 but outside the sub-panel 477. Alternatively, the editing interface 475 may also be expanded to occupy the entire main panel 420. Each user may determine their own view options independently, to decide how much of the user interface 400 is occupied by the editing interface 475 and/or the sub-panel 477.

The editing interface 475 includes input and formatting controls 480, including but not limited to toolbars, menus, and cells for data and/or functions. The editing interface includes navigation controls, such as a vertical scroll bar 482 and tabs 483 that allow other users to independently scroll individual worksheets, and browse different worksheets, of the spreadsheet document within the editing interface 475.

FIG. 4J shows an example of collaborative sharing of a web page within an editing interface 485, according to some embodiments. The editing interface 485 is shown within a sub-panel 487 of the main panel 420, that hides some or all of the thumbnails 410. In this example, the “front of room” option is enabled, that shows presenters 425 in a banner 430, within the main panel 420 but outside the sub-panel 487. Alternatively, the editing interface 485 may also be expanded to occupy the entire main panel 420. Each user may determine their own view options independently, to decide how much of the user interface 400 is occupied by the editing interface 485 and/or the sub-panel 487.

The editing interface 485 includes input controls 490, including but not limited to URL entry. The editing interface includes navigation controls, such as a vertical scroll bar 492 that allows other users to independently scroll the web page, and browse different web pages, within the editing interface 485.

FIG. 4K shows an example of collaborative editing of programming code within an editing interface 495, according to some embodiments. The editing interface 495 is shown within a subpanel 497 of the main panel 420, that hides all of the thumbnails 410. In this example, the “front of room” option is enabled, that shows presenters 425 in a banner 430, within the main panel 420 but outside the subpanel 497. Alternatively, the editing interface 495 may also be expanded to occupy the entire main panel 420. Each user may determine their own view options independently, to decide how much of the user interface 400 is occupied by the editing interface 495 and/or the subpanel 497.

The editing interface 495 includes a code editing area 498. The editing interface 495 includes navigation controls, such as a file browser 499 that allows other users to independently edit different source code files, within the editing interface 495.

In some embodiments, the particular user may override other users' views of the shared file, by converting the collaboration session to a share session. A “share” command may be different from a “collaborate” command in that the share command may not permit collaborative editing, and all the other users would be limited to view-only access of the file, and further, may be unable to independently navigate the file. The “share” command may be received through the editing interface (e.g., editing interfaces 455, 465, 475, 485, and 495) during the collaboration session.

In the example of FIG. 4J, the particular user may temporarily initiate a share session of the file and override the collaboration by clicking the share control 493 (here, a button labeled “Share with Meeting”). The share session may be reverted to a collaboration by clicking the same button as a toggle, for example.

At 360, the process 300 receives simultaneously through the editing interface, editing inputs from multiple users, including but not limited to the particular user. The process 300 modifies (at 370) the shared file based on the editing inputs, in real-time, and displays (at 380) the modified file within the editing interface in real-time to all the users, so that all the users see the file modifications as they are being made.

In some embodiments, the particular user may end the collaboration of the file by selecting a termination input. For example, the termination input may be the same collaborate control 435, as a toggle to activate and de-activate the collaboration mode. Ending the collaboration mode reverts the user interface to the grid of the thumbnails 410 for all users. The modified file is returned to the particular user.

In some embodiments, the user interface includes a chat interface, to answer queries pertaining to files shared for collaboration. For example, in some embodiments, the chat interface is a natural language interface that uses an artificial intelligence agent to answer the queries pertaining to the shared files.

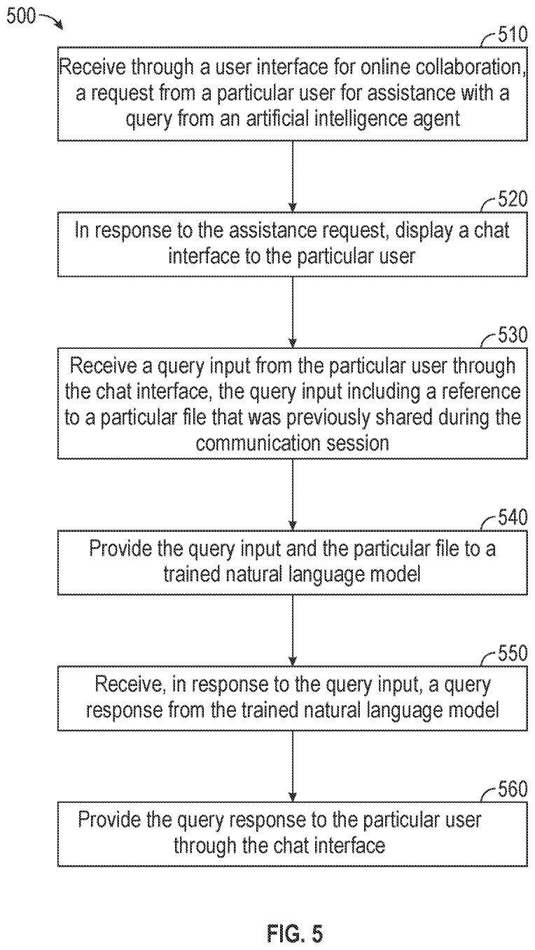

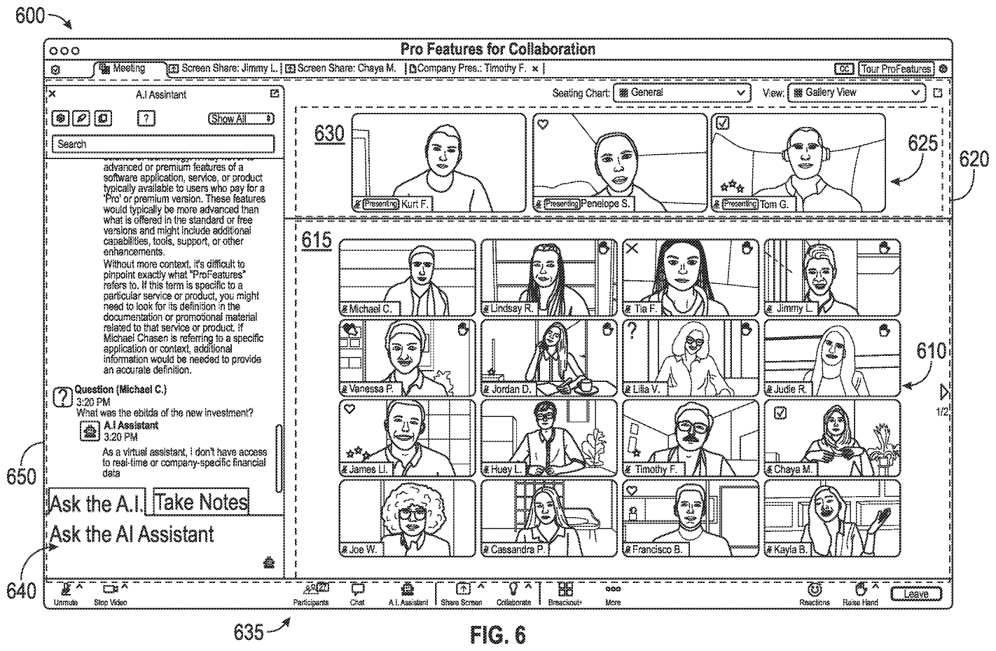

FIG. 5 is a flowchart illustrating a process 500 for online collaboration and query of a file, performed by a client device (e.g., client device 110, etc.) and/or a client server (e.g., server 130, etc.), according to some embodiments. In some embodiments, one or more operations in process 500 may be performed by a processor circuit (e.g., processors 212, etc.) executing instructions stored in a memory circuit (e.g., memories 220, etc.) of a system (e.g., system 200, etc.) as disclosed herein. For example, operations in process 500 may be performed by collaboration application 222, collaboration application engine 232, or some combination thereof. Moreover, in some embodiments, a process consistent with this disclosure may include at least operations in process 500 performed in a different order, simultaneously, quasi-simultaneously, or overlapping in time. The process 500 will be discussed with reference to an exemplary example shown in FIG. 6, which is described in further detail below. The process 500 may also be performed as an operation performed during and/or as part of process 300, which was described above.

FIG. 6 shows another example of a user interface 600, according to some embodiments. The user interface 600 is similar to the embodiment of the user interface 400 discussed above with respect to FIGS. 4A to 4K, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

At 510, the process 500 receives through a user interface, a request from a particular user for assistance with a query from an artificial intelligence agent. In response to the assistance request, the process 500 displays (at 520) a chat interface to the particular user. In some embodiments, the chat interface is adapted for queries by users regarding files that were shared for collaboration during the real-time communication session between users participating in the communication session.

As an example, FIG. 6 shows a user interface 600 for online collaboration and queries, according to some embodiments. The user interface 600 shows a grid of user thumbnails 610 in a subpanel 615 of the main panel 620. In this example, a “front of room” option is enabled, that shows presenters 625 in a banner 630 within the main panel 620, but outside the subpanel 615. The user interface 600 also includes a chat interface 640, displayed in a sidebar 650 of the main panel 620 that is separate from the subpanel 615 and the banner 630. In some embodiments, the sidebar 650 and/or the chat interface 640 may be shown within the user interface 600 in response to an “assistance” control 635 being clicked by the particular user.

At 530, the process 500 receives a query input from the user through the chat interface (e.g., chat interface 640), the query input including a reference to a particular file that was previously shared during the communication session.

At 540, the process 500 provides the query input and the particular file to a trained natural language model. In some embodiments, the particular file was uploaded to a storage (e.g., database 152) that is part of the collaboration system (e.g., system 200), and the trained natural language model retrieves the particular file from the storage, or the process 500 provides the particular file to the trained natural language model. The particular file may, for example, be provided to the trained natural language model at the time it is first shared during the communication session. As another example, the particular file may be cached, and provided to the trained natural language model along with the query as part of a single prompt.

In some embodiments, the trained natural language model is one of a machine learning model, a neural network, a large language model, or another type of artificial intelligence system, that was previously trained.

At 550, the process 500 receives, in response to the query input, a query response from the trained natural language model. The process 500 provides (at 560) the query response to the particular user through the chat interface (e.g. chat interface 640).

In some embodiments, the user interface includes a navigation interface for switching between files or other content being shared by multiple users during a real-time communication session. For example, in some embodiments, the navigation interface is a tabbed interface with each tab corresponding to a user that is actively sharing a file.

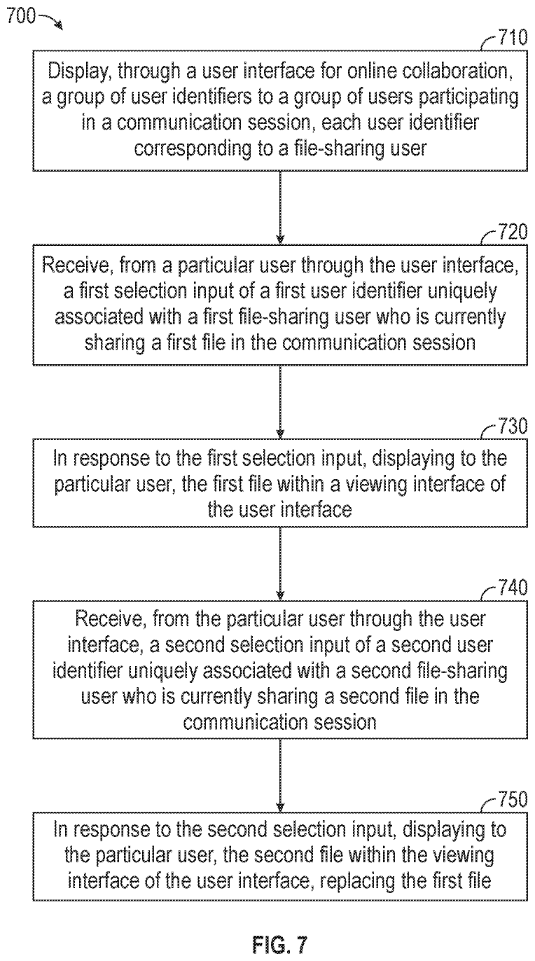

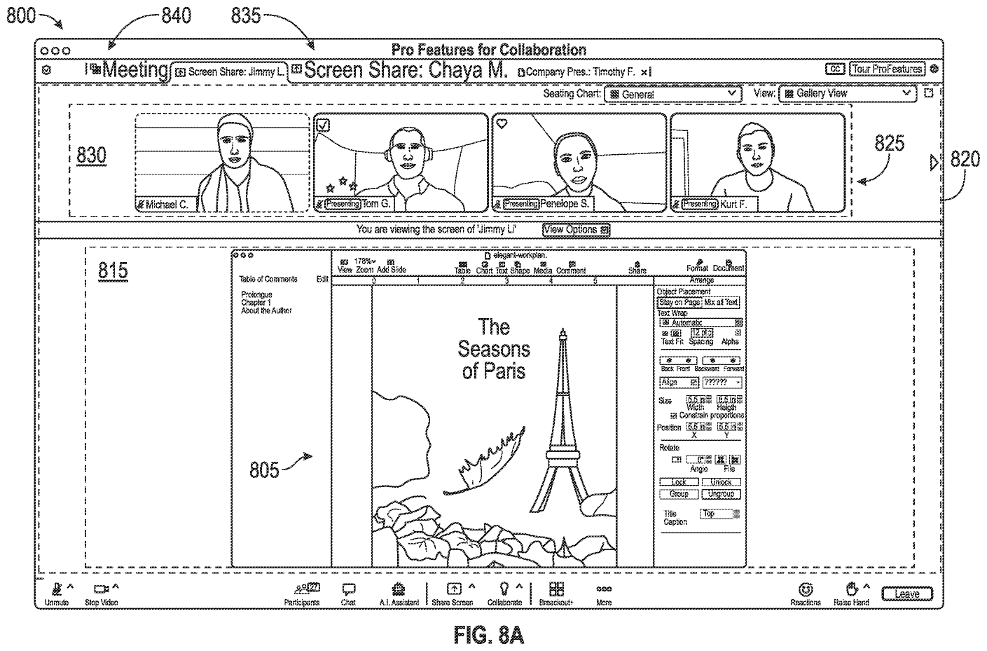

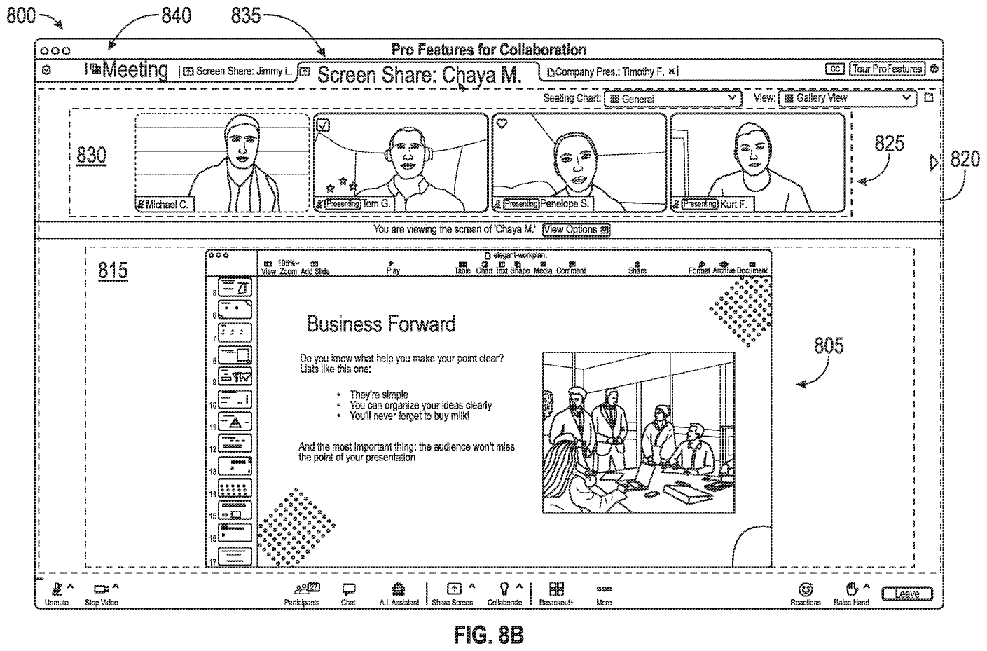

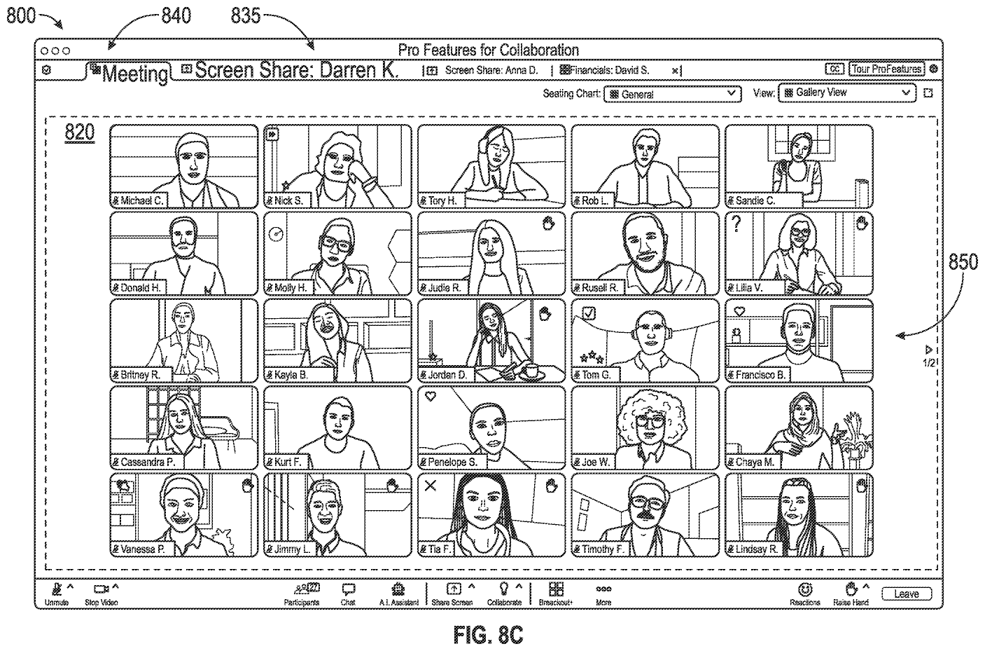

FIG. 7 shows a flowchart illustrating a process 700 for online collaboration performed by a client device (e.g., client device 110, etc.) and/or a client server (e.g., server 130, etc.), according to some embodiments. In some embodiments, one or more operations in process 700 may be performed by a processor circuit (e.g., processors 212, etc.) executing instructions stored in a memory circuit (e.g., memories 220, etc.) of a system (e.g., system 200, etc.) as disclosed herein. For example, operations in process 700 may be performed by collaboration application 222, collaboration application engine 232, or some combination thereof. Moreover, in some embodiments, a process consistent with this disclosure may include at least operations in process 700 performed in a different order, simultaneously, quasi-simultaneously, or overlapping in time. The process 700 will be discussed with reference to an exemplary example shown in FIGS. 8A and 8B, which is described in further detail below. The process 700 may also be performed as an operation performed during and/or part of process 300, which was described above.

FIGS. 8A and 8B show another example of a user interface 800, according to some embodiments. The user interface 800 is similar to the embodiments of the user interface 400 and user interface 600, discussed above with respect to FIGS. 4A to 4K and FIG. 6, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

At 710, the process 700 displays, through a user interface for online collaboration, a group of user identifiers to a group of users participating in a communication session, each user identifier corresponding to a file-sharing user. As an example, FIG. 8A shows a user interface 800 for online collaboration and sharing, according to some embodiments. The user interface 800 shows a viewing interface 805 within a subpanel 815 of the main panel 820. In this example, a “front of room” option is enabled, that shows presenters 825 in a banner 830 within the main panel 820, but outside the subpanel 815. A row of tabs 835 is arranged above the main panel 820, each tab labeled with a user identifier and corresponding to a user in the session who is sharing a file.

In some embodiments, presenters may be users who are sharing their screen, but who are not necessarily sharing a file, whereas file-sharing users are actively sharing a file or other resource. The tabs 835 may in some embodiments correspond only to file-sharing users or may correspond to all users who are sharing a screen, or correspond to any other group of users.

At 720, the process 700 receives, from a particular user through the user interface, a first selection input of a first user identifier uniquely associated with a first file-sharing user who is currently sharing a first file in the communication session. At 730, in response to the first selection input, the process 700 displays to the particular user, the first file within a viewing interface (e.g., viewing interface 805) of the user interface.

As an example, in FIG. 8A, the particular user has selected the first tab which corresponds to a first user (“Jimmy Li”) who is sharing a word processing document (“The Seasons of Paris”). Since the tab corresponding to the first user is selected, the word processing document is displayed in the viewing interface 805.

At 740, the process 700 receives from the particular user through the user interface, a second selection input of a second user identifier uniquely associated with a second file-sharing user who is currently sharing a second file in the communication session. At 750, in response to the second selection input, the process 700 displays to the particular user, the second file within a viewing interface (e.g., viewing interface 805) of the user interface, replacing the first file.

As a further example, in FIG. 8B, the particular user has now selected the second tab which corresponds to a second user (“Chaya Meyer”) who is sharing a presentation document (“Business Forward”). Since the tab corresponding to the second user is selected, the presentation document is displayed in the viewing interface 805, replacing the previously displayed word processing document.

In some embodiments, the navigation interface for switching between shared files also includes an option for returning to the meeting. As a further example, in FIG. 8C, the particular user has selected another tab 840, which does not correspond to any user, but instead represents the meeting as a whole (“Meeting”). When the tab corresponding to the meeting is selected, the viewing interface 805 and subpanel 815 are hidden from the main panel 820 and are replaced with a grid of thumbnails 850 that occupies the entire main panel 820.

In the example of FIG. 8C, “front of room” is not enabled, and so banner 830 is not displayed within the main panel 820. In some embodiments, selecting the option to end sharing-view and returning to the meeting results in a default view of just the thumbnails 850, or another default view that the user may customize as desired (e.g., “front of room,” etc.).

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for online collaboration, comprising:
displaying to a plurality of users, a user interface for a real-time communication session between the plurality of users;
displaying a plurality of thumbnails within a first region of the user interface to the plurality of users, each thumbnail in the plurality of thumbnails corresponding to a user in the plurality of users, the first region of the user interface comprising a second region of the user interface;
receiving through the user interface a selection input from a particular user of the plurality of users, the selection input comprising a selection of a particular file;
in response to the selection input, displaying an editing interface within the second region of the user interface to the plurality of users, the editing interface adapted for real-time editing of files by the plurality of users;
displaying the particular file within the editing interface to the plurality of users;
receiving simultaneously through the editing interface, a first editing input from a first user and a second editing input from a second user;
modifying the particular file in response to the first editing input and the second editing input, resulting in a modified file; and
displaying the modified file within the editing interface to the plurality of users.

2. The method of claim 1, wherein displaying the plurality of thumbnails within the first region of the user interface comprises displaying at least one thumbnail within the second region of the user interface, and
displaying the editing interface within the second region of the user interface to the plurality of users comprises replacing, for all the users in the plurality of users, the at least one thumbnail with the editing interface.

3. The method of claim 2, further comprising:
receiving through the user interface a termination input from the particular user; and
in response to the termination input, replacing, for all the users in the plurality of users, the editing interface with the at least one thumbnail.

4. The method of claim 3, further comprising:
further in response to the termination input, providing the modified file to a storage location associated with the particular user.

5. The method of claim 3, wherein receiving the selection input comprises receiving a selection of a particular options parameter from a plurality of options parameters,
the plurality of options parameters comprising a first option to remove all permissions from the plurality of users other than the particular user once the termination input is received, and
the plurality of options parameters comprising a second option to provide a copy of the modified file to the plurality of users other than the particular user once the termination input is received.

6. The method of claim 1, wherein the editing interface comprises a navigation interface adapted for real-time navigation of files by the plurality of users, and displaying the particular file within the editing interface to the plurality of users comprises displaying a first portion of the particular file within the editing interface to the plurality of users, the method further comprising:
receiving through the navigation interface, a navigation input from a third user; and
in response to receiving the navigation input, displaying a second portion of the particular file within the editing interface only to the third user.

7. The method of claim 6, wherein the navigation input is a first navigation input, the method further comprising:
receiving, through the navigation interface, a second navigation input from the particular user;
in response to receiving the second navigation input, displaying a third portion of the particular file within the editing interface only to the particular user;
receiving through the user interface, a share command; and
in response to receiving the share command, displaying the third portion of the particular file within the editing interface to all the users in the plurality of users.

8. The method of claim 6, wherein the third user is the first user.

9. The method of claim 6, wherein the navigation interface comprises at least one of scroll bars, tabs, and filters.

10. The method of claim 1, wherein receiving the selection input comprises selecting a storage location associated with the particular user, and
displaying the particular file comprises copying the particular file from the storage location associated with the particular user to a remote storage that is not associated with any user in the plurality of users.

11. The method of claim 10, wherein the storage location associated with the particular user is one of a local storage, a network-attached storage, and a cloud storage.

12. The method of claim 1, wherein the plurality of thumbnails are a first plurality of thumbnails, the first plurality of thumbnails comprising a second plurality of thumbnails, each thumbnail in the second plurality of thumbnails corresponding to a file-sharing user, the method further comprising:
while displaying the editing interface within the second region of the user interface, displaying the second plurality of thumbnails within the first region of the user interface and outside the second region of the user interface.

13. The method of claim 1, wherein the particular file is one of a document, a spreadsheet, a presentation, a web page, a video, a program, a form, a poll, and a whiteboard.

14. The method of claim 1, wherein receiving the selection input comprises receiving a selection of a particular permissions parameter from a plurality of permissions parameters, wherein the particular permissions parameter is applicable to the plurality of users other than the particular user, the plurality of permissions parameters comprising view-only permission, comment permission, and edit permission.

15. The method of claim 1, wherein the particular user is the first user.

16. The method of claim 1, wherein the editing interface comprises input controls and formatting controls.

17. The method of claim 1, wherein each thumbnail in the plurality of thumbnails is one of a user avatar, a user image, a user video, a live user video feed, and a user text identifier.

18. The method of claim 1, wherein the plurality of thumbnails are sortable according to a plurality of user criteria, the plurality of user criteria comprising user first name, user last name, user sharing, and user reactions.

19. A non-transitory computer-readable medium storing a program for online collaboration, which when executed by a computer, configures the computer to:
display to a plurality of users, a user interface for a real-time communication session between the plurality of users;
display a plurality of thumbnails within a first region of the user interface to the plurality of users, each thumbnail in the plurality of thumbnails corresponding to a user in the plurality of users, the first region of the user interface comprising a second region of the user interface;
receive through the user interface a selection input from a particular user of the plurality of users, the selection input comprising a selection of a particular file;
in response to the selection input, display an editing interface within the second region of the user interface to the plurality of users, the editing interface adapted for real-time editing of files by the plurality of users;
display the particular file within the editing interface to the plurality of users;
receive simultaneously through the editing interface, a first editing input from a first user and a second editing input from a second user;
modify the particular file in response to the first editing input and the second editing input, resulting in a modified file; and
display the modified file within the editing interface to the plurality of users.

20. A system for online collaboration, comprising:
a processor; and
a non-transitory computer-readable medium storing a set of instructions, which when executed by the processor, configure the processor to:
display to a plurality of users, a user interface for a real-time communication session between the plurality of users;
display a plurality of thumbnails within a first region of the user interface to the plurality of users, each thumbnail in the plurality of thumbnails corresponding to a user in the plurality of users, the first region of the user interface comprising a second region of the user interface;
receive through the user interface a selection input from a particular user of the plurality of users, the selection input comprising a selection of a particular file;
in response to the selection input, display an editing interface within the second region of the user interface to the plurality of users, the editing interface adapted for real-time editing of files by the plurality of users;
display the particular file within the editing interface to the plurality of users;
receive simultaneously through the editing interface, a first editing input from a first user and a second editing input from a second user;
modify the particular file in response to the first editing input and the second editing input, resulting in a modified file; and
display the modified file within the editing interface to the plurality of users.
